(19) United States
(12) Patent Application Publication
(10) Pub. No.: US 2019/0059073 A1
(43) Pub. Date: Feb. 21, 2019

(54) ALLOCATION OF APPLICATION SIGNALLING SESSION

(71) Applicant: Telefonaktiebolaget LM Ericsson (publ), Stockholm (SE)

(72) Inventors: Haogang Xu, Täby (SE); Joakim Åkesson, Landvetter (SE)

(21) Appl. No.: 16/083,290

(22) PCT Filed: Feb. 22, 2017
(86) PCT No.: PCT/EP2017/054098

§ 371 Date: Sep. 7, 2018

Related U.S. Application Data
(60) Provisional application No. 62/319,504, filed on Apr. 7, 2016.

(51) Int. Cl. H04W 72/00; H04L 12/18; H04L 1/00; H04W 4/08; H04W 72/04; H04W 8/02

(52) U.S. Cl. CPC H04W 72/005; H04L 12/189; H04L 1/0003; H04W 8/02; H04W 4/08; H04W 72/0446; H04L 1/0009

(57) ABSTRACT

There is provided mechanisms for allocating an application signalling session for transmitting Multimedia Broadcast Multicast Services (MBMS) data in an MBMS Single Frequency Network (MBSFN). A method is performed by a radio access network node. The method comprises obtaining information identifying the application signalling session from a broadcast multicast service center (BM-SC). The method comprises allocating the application signalling session to a subframe of a radio frame, in which subframe a signalling modulation and coding scheme (MCS) of the radio frame is used.

### TECHNICAL FIELD

Embodiments presented herein relate to a method, a radio access network node, a computer program, and a computer program product for allocating an application signalling session for transmitting Multimedia Broadcast Multicast Services data in an MBMS Single Frequency Network.

### BACKGROUND

Cellular communication systems have become commonplace and are used by a large majority of people for person-to-person communication. Moreover, with the increasing use of smartphones, digitally distributed content is more and more consumed on wireless devices. While the delivery of a large part of such content, e.g. web pages, needs to be directly controllable by the user, the delivery of media content, such as video, can in many cases be shared by several users.

In order to increase efficiency of shared media consumption, point-to-multipoint systems such as broadcasting and/or multicasting can be used. In this way, network resources are shared between receiving wireless devices to a higher degree. A set of related standards for point-to-multipoint content delivery using cellular communication systems is 3GPP MBMS (3rd Generation Partnership Project-Multimedia Broadcast Multicast Service) and 3GPP eMBMS (evolved MBMS).

One concept in eMBMS is the MBSFN (MBMS Single Frequency Network) transmission, sometimes also referred to as multi-cell MBMS transmission using MBSFN operation-in a MBSFN area. An MBSFN area comprises multiple cells in which transmission of the same waveforms is performed at the same time. A property of MBSFN transmission is that all participating cells transmit the same content in a synchronized manner so it appears as one transmission to the wireless device. This gives the possibility for wireless devices to combine MBMS transmissions from multiple cells. Transmitting the same data to multiple wireless devices allows network resources to be shared.

Many broadcasting applications need an application level signaling service, such as the service announcement channel for live video services and group calls and MBMS session mapping signal in mission critical push to talk (MCPTT), and the service normally require a very low packet loss rate (i.e., a comparatively low modulation and coding scheme (MCS) need to be used) in order to make sure the signaling information can be received by all the wireless devices in the MBSFN, no matter where the wireless devices are located in the MBSFN.

It would thus be of benefit if resource allocation can be made more flexible in the MBSFN.

### SUMMARY

It is an object to provide more efficient mechanisms for how MBMS sessions are allocated in an MBSFN.

According to a first aspect there is presented a method for allocating an application signalling session for transmitting Multimedia Broadcast Multicast Services (MBMS) data in an MBMS Single Frequency Network (MBSFN). The method is performed by a radio access network node. The method comprises obtaining information identifying the application signalling session from a broadcast multicast service center (BM-SC). The method comprises allocating the application signalling session to a subframe of a radio frame, in which subframe a signalling modulation and coding scheme (MCS) of the radio frame is used.

Advantageously this provides a flexible allocation of MBMS sessions in an MBSFN.

Advantageously this enables efficient use of available resources and thus improves the user experience of eMBMS transmissions.

According to a second aspect there is presented a radio access network node for allocating an application signalling session for transmitting MBMS data in an MBSFN. The radio access network node comprises processing circuitry. The processing circuitry is configured to cause the radio access network node to obtain information identifying the application signalling session from an BM-SC. The processing circuitry is configured to cause the radio access network node to allocate the application signalling session to a subframe of a radio frame, in which subframe a signalling MCS of the radio frame is used.

According to a third aspect there is presented a radio access network node for allocating an application signalling session for transmitting MBMS data in an MBSFN. The radio access network node comprises processing circuitry and a computer program product. The computer program product stores instructions that, when executed by the processing circuitry, causes the radio access network node to perform steps, or operations. The steps, or operations, involve the radio access network node to obtain information identifying the application signalling session from an BM-SC. The steps, or operations, involve the radio access network node to allocate the application signalling session to a subframe of a radio frame, in which subframe a signalling MCS of the radio frame is used.

According to a fourth aspect there is presented a radio access network node for allocating an application signalling session for transmitting MBMS data in an MBSFN. The radio access network node comprises an obtainer module configured to obtain information identifying the application signalling session from an BM-SC. The radio access network node comprises an allocator module configured to allocate the application signalling session to a subframe of a radio frame, in which subframe a signalling MCS of the radio frame is used.

According to a fifth aspect there is presented a computer program for allocating an application signalling session for transmitting MBMS data in an MBSFN, the computer program comprising computer program code which, when run on a radio access network node, causes the radio access network node to perform a method according to the first aspect.

According to a sixth aspect there is presented a computer program product comprising a computer program according to the fifth aspect and a computer readable storage medium on which the computer program is stored.

It is to be noted that any feature of the first, second, third, fourth, fifth and sixth aspects may be applied to any other aspect, wherever appropriate. Likewise, any advantage of the first aspect may equally apply to the second, third, fourth, fifth and/or sixth aspect, respectively, and vice versa. Other objectives, features and advantages of the enclosed embodiments will be apparent from the disclosure herein as well as from the drawings.

Generally, all terms used herein are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Certain aspects and features of the inventive concept are now described, by way of example, with reference to the accompanying drawings, in which:

FIGS. 1 and 11 are schematic diagrams illustrating communication networks according to embodiments;

FIG. 2 schematically illustrates resource allocation in subframes of radio frames according to state of the art;

FIGS. 3 and 4 schematically illustrate resource allocation in subframes of radio frames according to embodiments;

FIGS. 5, 6 and 7 are flowcharts of methods according to embodiments;

FIG. 8 is a schematic diagram showing functional units of a radio access network node according to an embodiment;

FIG. 9 is a schematic diagram showing functional modules of a radio access network node according to an embodiment; and

FIG. 10 shows one example of a computer program product comprising computer readable storage medium according to an embodiment.

### DETAILED DESCRIPTION

Certain embodiments will now be described more fully hereinafter with reference to the accompanying drawings. The inventive concept may, however, be embodied in many different forms and should not be construed as limited to the embodiments set forth herein; rather, these embodiments are provided by way of example to help to convey the scope of the inventive concept to those skilled in the art. Like numbers refer to like elements throughout the description. Any step or feature illustrated by dashed lines should be regarded as optional.

The herein disclosed embodiments generally relate to mechanisms for transmitting MBMS data in an Evolved Universal Terrestrial Radio Access Network (E-UTRAN).

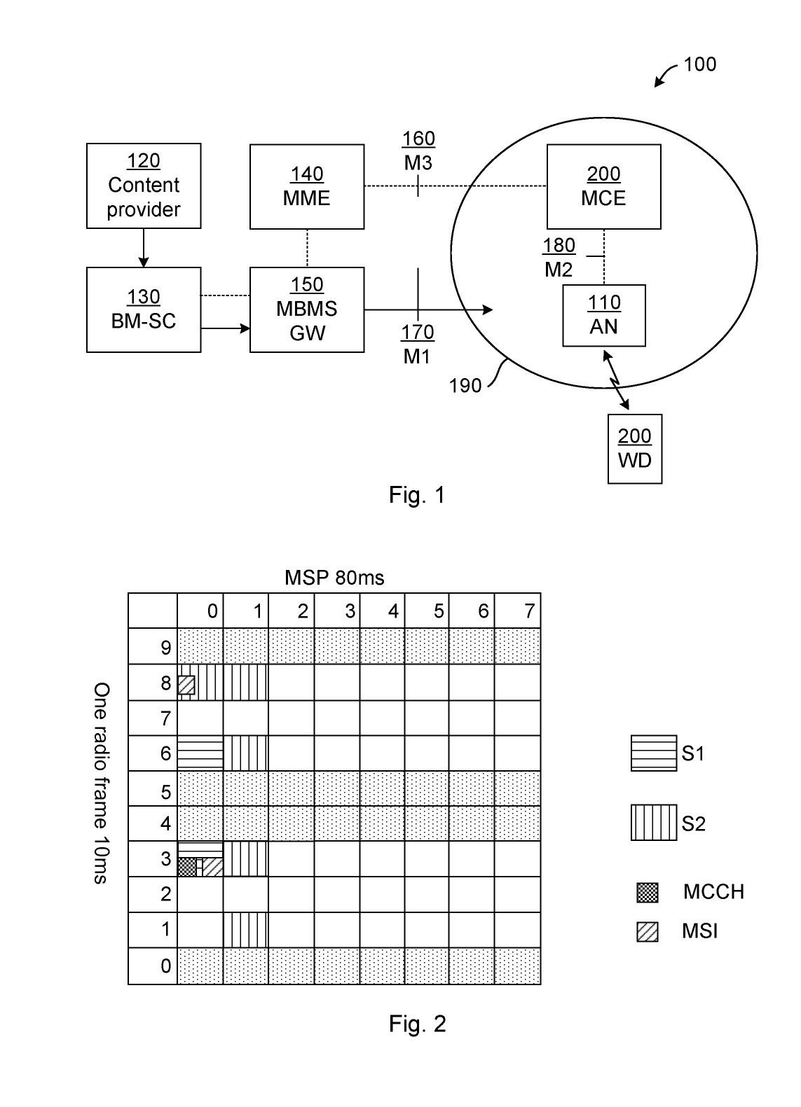

FIG. 1 is a schematic diagram illustrating a communications network 100 where embodiments presented herein can be applied. A radio access network 190 comprises one or more access nodes (AN) 110, here each in the form of a radio base station such as an evolved Node B, also known as an eNode B or eNB. Each one of the access nodes 110 could also be in the form of a Node B, BTS (Base Transceiver Station) and/or BSS (Base Station Subsystem), etc., as long as the embodiments presented herein are applicable. The access nodes 110 provide radio connectivity to one or more wireless devices 200. The wireless device 200 shown here is capable of receiving a broadcast and/or a multicast content feed. The term wireless device is also known as mobile communication terminal, user equipment, mobile terminal, user terminal, user agent, machine-to-machine device etc., and can be, for example, what today are commonly known as a mobile phone, smart phone or a tablet/laptop with wireless connectivity or a fixed mounted terminal. The radio access network 190 further comprises a Multi-cell/multicast Coordination Entity (MCE) 200. The functions of the MCE 200 are, for example, admission control and the allocation of radio resources used by all network nodes 110 in the MBSFN.

The AN 110 and the MCE 200 are example of radio access network nodes. The AN 110 and the MCE 200 are interconnected via a control plane interface 180 denoted M2 and could be provided in separate physical devices, or be co-located and thus share the same physical hardware.

In the former alternative the MCE 200 controls the allocation of radio resources used by all access nodes 110 in the MBSFN for the MBSFN transmission. Hence, the transmission of the allocation of radio resources to the wireless devices 200 in the same MBSFN area is performed in the same manner by all network nodes 110. In the latter alternative, the allocation of radio resources for the radio transmission can be configured by another configuration node, such as, by an Operation Support Systems (OSS) node. It is then up to each of the access nodes 110 in the same MBSFN area to transmit the allocation of radio resources to the wireless devices 200. Hence, according to one scenario there is a single MCE 200 in the radio access network 190 and according to another scenario there are as many MCEs as there are ANs. The herein disclosed embodiments are not limited to any of these scenarios.

The radio access network 190 may e.g. comply with any one or a combination of LTE-SAE (Long Term Evolution-System Architecture Evolution), W-CDMA (Wideband Code Division Multiplex), EDGE (Enhanced Data Rates for GSM (Global System for Mobile communication) Evolution), GPRS (General Packet Radio Service), CDMA2000 (Code Division Multiple Access 2000), or any other current or future wireless network, such as LTE-Advanced, as long as the embodiments described hereinafter are applicable.

The radio access network 190 further comprises components to support broadcast content, in a broadcast or a multicast way, i.e. multiple wireless devices 200 can receive the same content in a point-to-multipoint fashion. This increases network efficiency, e.g. compared to point-to-point streaming, also known as unicast. The components for broadcast comply with any suitable standard, e.g. 3GPP MBMS (3rd Generation Partnership Project Multimedia Broadcast Multicast Service), 3GPP MBMS Evolution, 3GPP IMB (Integrated Mobile Broadcast), 3GPP eMBMS (Evolved MBMS), DVB-H (Digital Video Broadcasting-Handheld), DVB-NGH (Digital Video Broadcasting-Next Generation Handheld), or any other current or future broadcast system over wireless networks, as long as the principles described hereinafter are applicable. In this document, embodiments are presented as applied in 3GPP MBMS release 6 or later, but it is to be understood that this does not imply that any other standard is excluded.

A Broadcast Multicast Service Center (BM-SC) 130 is provided to control the general flow of content from content providers (CP) 120 to the wireless devices 200, including providing both content and metadata at appropriate points in time.

An MBMS gateway (MBMS-GW) 150 connects the BM-SC 130 with the radio access network 190 and access nodes 110 over a user plane interface 170 denoted M1 Moreover, the MBMS-GW 150 is responsible for session management, etc. The MBMS-GW 150 is thus an entity that is logically provided between the BM-SC 130 and access nodes 110. The MBMS-GW 150 is configured to send/broadcast MBMS packets to each one of the access nodes 110 transmitting the service. The MBMS-GW 150 performs MBMS Session Control Signaling towards the radio access network 190, such as E-UTRAN (Evolved Universal Terrestrial Radio Access Network), via a Mobility Management Entity (MME) 170. The MME 170 is a control node for the radio access network 190 an operatively connected to the same over a control interface 160 denoted M3.

An MBMS session corresponds to an MBMS service, i.e. one media transmission. Internet Protocol (IP) multicast can be used for point-to-multipoint delivery of user packets from the MBMS-GW 150 to the access nodes 110. The point to multipoint delivery of content is an efficient way to deliver the same content to large number of wireless devices in terms of frequency spectrum usage. In the radio interfaces between the access nodes 110 and the wireless devices 200, this can be based on single frequency network (SFN) technology. This means that once the multiple signals from multiple cells (as defined by cell-specific signalling transmitted by the access nodes 110) are tightly synchronized, the multiple signals received from multiple cells (such as from different network nodes 110) appear at the wireless devices 200 as multi-paths of same signal transmission. In this way, the multiple signals do not interfere with each other but contribute to a useful signal which could be combined to enhance received signal strength.

In order not to obscure the concepts presented herein, other (sometimes optional) network nodes such as Radio Network Controller, GGSN (Gateway GPRS (general packet radio service) support node), SGSN (serving GPRS support node), are omitted from FIG. 1, but may be used as needed during operation. Other components not required to present the embodiments presented herein are omitted for reasons of clarity.

For the transport of MBMS data over the radio interface, the 3GPP specification defines the Multicast Channel (MCH) transport channel, capable of SFN transmission and the MBMS Control Channel (MCCH) and the MBMS Traffic Channel (MTCH) logical channels. The MCCH and MTCH logical channels are mapped onto the MCH transport channel. An MSI (MCH Scheduling Information) Medium Access Control (MAC) control element is included in the first subframe allocated to the MCH within the MCH scheduling period to indicate the position of each MTCH and unused subframes on the MCH. The wireless devices 200 can assume that the first scheduled MTCH starts immediately after the MCCH or the MCH Scheduling Information MAC control element if the MCCH is not present, and the other scheduled MTCH(s) start immediately after the previous MTCH, at the earliest in the subframe where the previous MTCH stops.

MSI and potential MCCH may be mapped to one subframe together with one or a few MTCHs, i.e. they are carried in one MAC packet data unit (PDU). In order to secure the MCCH and MSI robust receiving at the border of the MBSFNs, the corresponding MAC PDU is encoded with the signaling MCS which is defined in system information block (SIB) 13 for the MBSFN. The other subframes carrying only MTCHs will use the data MCS which is defined in the MCCH for the Physical Multicast Channel (PMCH).

FIG. 2 is schematic illustration of resource allocation in subframes 0-9 of radio frames 0-7 for a MCH Scheduling Period (MSP) of 80 ms according to state of the art. With reference to FIG. 2 schematically illustrating dedicated MCH for an application signaling service denoted S1, the MCE 200 allocate S1 in the first MCH with MCS 3, and allocate a further application data service denoted S2 in the second MCH with data MCS 7. S1 is multiplexed together with the MSI of the MCH and the MCCH of the MBSFN in subframe 3 of radio frame 0, i.e. the first subframe in the MCH, and encoded in a MAC PDU with signaling MCS 2, and subframe 6 of radio frame 0 is dedicated for S1 and encoded in a MAC PDU with data MCS3. S2 is multiplexed together with the MSI of the second MCH in subframe 8 of radio frame 0, i.e. the first subframe of the second MCH, and encoded in a MAC PDU with signaling MCS2, and the remaining 4 subframes are dedicated for S2 and encoded in MAC PDU with data MCS 7.

As disclosed above, many broadcasting applications need an application level signaling service, such as the service announcement channel for live video services and group calls and MBMS session mapping signal in MCPTT, and the service normally require a very low packet loss rate (i.e., a comparatively low MCS need to be used) in order to make sure the signaling information can be received by all the wireless devices in the MBSFN, no matter where the wireless devices are located in the MBSFN.

As disclosed with reference to FIG. 2, the common approach is that MCE 200 sets up a separate MCH with low data MCS to encode the MAC PDUs in order to achieve low packet loss rate, i.e. that S1 is mapped to a dedicated MCH with (low) data MCS 3. As can be seen in FIG. 2, subframe 8 of radio frame 0 is also encoded with MCS 2 instead of MCS 7 for the purpose of the MSI transmission of the second MCH, but S2 itself does not need so low MCS, and this means that S2 thereby only get roughly one third of the capacity compared with using MCS 7. S2 is thus forced to use a low MCS which S2 does not need and hence capacity is wasted in the subframe.

The embodiments disclosed herein relate to allocating an application signalling session for transmitting MBMS data in an MBSFN 100. In order to obtain such mechanisms there is provided a radio access network node 200, a method performed by the radio access network node 200, a computer program product comprising code, for example in the form of a computer program, that when run on a radio access network node 200, causes the radio access network node 200 to perform the method.

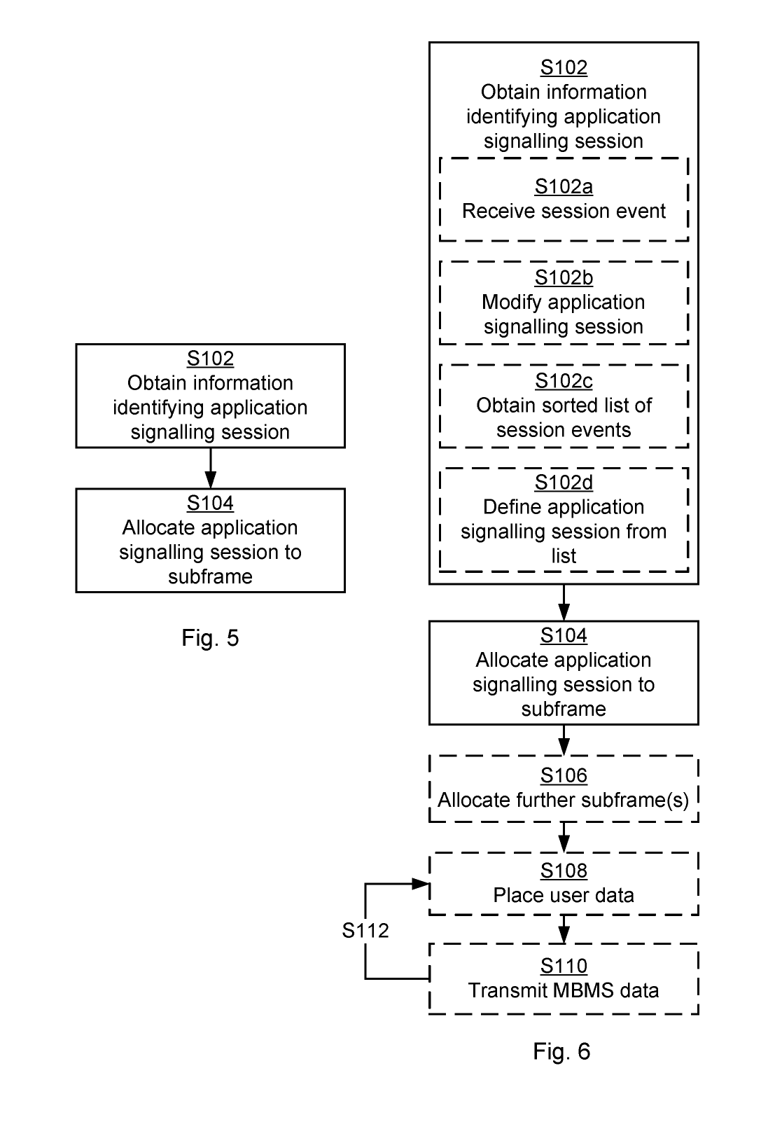

FIGS. 5, 6, and 7 are flowcharts illustrating embodiments of methods for allocating an application signalling session for transmitting MBMS data in an MBSFN 100. The methods are performed by the radio access network node 200. The methods are advantageously provided as computer programs 1020.

Reference is now made to FIG. 5 illustrating a method for allocating an application signalling session for transmitting MBMS data in an MBSFN 100 as performed by the radio access network node 200 according to an embodiment.

S102: The radio access network node 200 obtains information identifying the application signalling session from the BM-SC 130.

S104: The radio access network node 200 allocates the application signalling session to a subframe of a radio frame, in which subframe a signalling MCS of the radio frame is used.

Embodiments relating to further details of allocating an application signalling session for transmitting MBMS data in an MBSFN 100 will now be disclosed.

There can be different ways to define the first subframe. Different embodiments relating thereto will now be described in turn. According to an embodiment the subframe is a first available subframe where the MTCH is transmitted in the MCH. According to an embodiment the subframe is a first available subframe of a Multicast Channel Scheduling Period (MSP). According to an embodiment the subframe is a first available subframe in the radio frame where multicast Channel Scheduling Information (MSI) is transmitted. At least according to this latter embodiment the subframe is a first available subframe where a Multicast Control Channel (MCCH) is transmitted.

Advantageously, by enabling the application signaling session to be allocated in a subframe shared with MSI and/or MCCH, this will reduce the need for setting up a separate MCH with signaling level MCS, and it will reduce the total allocated radio resource for application signaling and data, and at the same time maintain the same or even better quality application signaling broadcast.

There can be different ways to define the signalling MCS. According to an embodiment the signalling MCS is defined in SIB 13 of a MBSFN configuration.

There may be different ways for the radio access network node 200 to obtain information identifying the application signalling session from the BM-SC 130 in step S102. According to aspects the information identifying the application signalling session originates from the BM-SC 130 itself. According to other aspects the information identifying the application signalling session originates from the CP 120 and hence, according to an embodiment, the information identifying the application signalling session is obtained from the CP 120 via the BM-SC 130.

Reference is now made to FIG. 6 illustrating methods for allocating an application signalling session for transmitting MBMS data in an MBSFN 100 as performed by the radio access network node 200 according to further embodiments. It is assumed that steps S102 and S104 are performed as described above and description thereof is therefore omitted.

There may be different ways for the radio access network node 200 to obtain the information identifying the application signalling session in step S102. Different embodiments relating thereto will now be described in turn.

According to some aspects the radio access network node 200 receives a session event (including e.g., session start, session update, and session stop) from the MME 140. Hence, according to an embodiment the radio access network node 200 is configured to perform step S102a as part of obtaining information identifying the application signalling session in step S102:

S102a: The radio access network node 200 receives a session event of the application signalling session from the MME 140.

According to some aspects the radio access network node 200 modifies (such as adds, updates, or removes) a corresponding session in a list of ongoing sessions. Hence, according to an embodiment the radio access network node 200 is configured to perform step S102b as part of obtaining information identifying the application signalling session in step S102:

S102b: The radio access network node 200 modifies the application signalling session in a list of ongoing sessions in response to having received the session event (as received in step S102a).

According to some aspects the radio access network node 200 identifies the application signalling session by sorting the parameter in the session event in a decreasing or increasing order, and selects the first one as the application signalling session. Hence, according to an embodiment the radio access network node 200 is configured to perform steps S102c and S102d as part of obtaining information identifying the application signalling session in step S102:

S102c: The radio access network node 200 obtains a sorted list of session events according to values of at least one parameter of the session events. The radio access network node 200 can obtain the sorted list by itself being configured to sort an unsorted list or receive an already sorted list.

S102d: The radio access network node 200 defines the information identifying the application signalling session as the session event occurring either first or last in the sorted list of session events. Whether to identify the application signalling session as the session event occurring either first or last in the sorted list of session events depends on how the list is sorted (i.e., in decreasing or increasing order).

There could be different kinds of parameters according to which the sorted list in step S102c is obtained. According to some aspects the radio access network node 200 identifies the application signalling session by comparing parameters such as Allocation and Retention Priority (ARP) priority, Quality of service Class Identifier (QCI) and Temporary Mobile Group Identity (TMGI) of the sessions within the MCH. Hence, according to an embodiment the parameter represent at least one of APR priority, QCI, and TMGI for the at least two sessions in the list.

If needed, the radio access network node 200 allocates one or more extra subframes with the signalling MCS, and hence according to an embodiment the radio access network node 200 is configured o perform step S106:

S106: The radio access network node 200 allocates at least one further subframe in the radio frame for the application signalling session. This at least one further subframe uses the signalling MCS of the radio frame.

There can be different ways to place user data of the application signalling session. According to aspects the user data of the application signalling session is placed in any left over part in the first subframe together with MSI and MCCH. Hence, according to an embodiment the radio access network node 200 is configured to perform step S108:

S108: The radio access network node 200 places user data of the application signalling session in any available part of the subframe.

The radio access network node 200 can then transmit the user data as MBMS payload. Hence, according to an embodiment the radio access network node 200 is configured to perform step S110:

S110: The radio access network node 200 transmits the user data as MBMS payload in the subframe.

Steps S108 and S110 can be repeated for each MSP cycle and hence according to an embodiment the radio access network node 200 is configured to, in a step S112, repeat steps S108 and S110 for each MSP cycle.

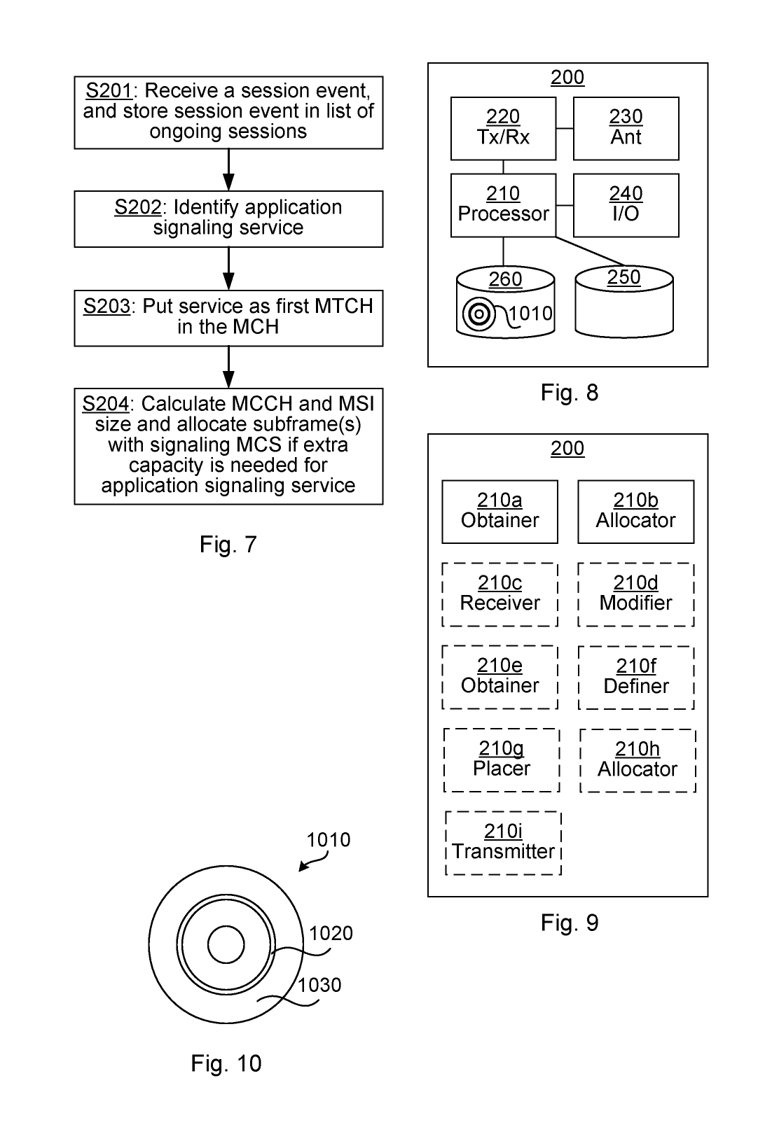

Reference is now made to FIG. 7 illustrating a method for allocating an application signalling session for transmitting MBMS data in an MBSFN 100 as performed by the radio access network node 200 according to one particular embodiment based on at least some of the embodiments disclosed with references to FIGS. 5 and 6. In the embodiment of FIG. 7 the functionality of the radio access network node 200 is implemented in an MCE.

In step S201, the MCE receive a session event, comprising at least one of a session start, session update and session stop, from the MME, and the MCE adds, updates, or removes the corresponding sessions in a list of ongoing sessions.

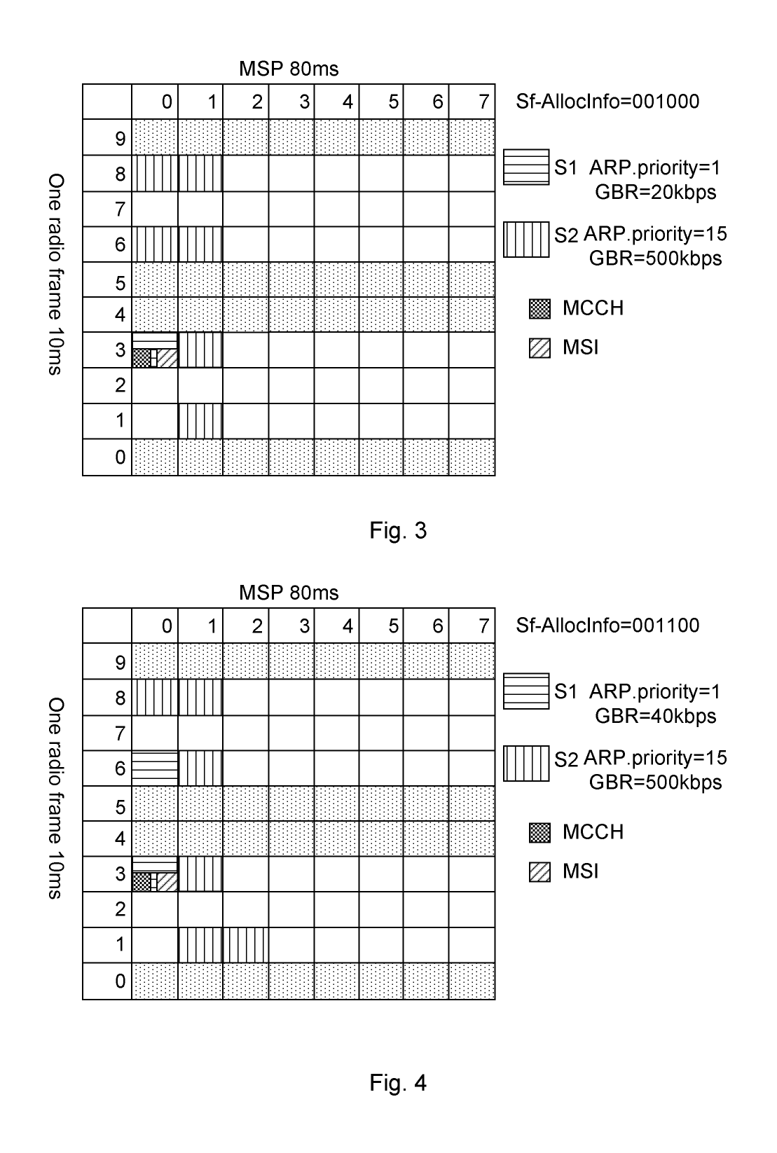

In step S202, the MCE identifies the application signaling session by using a pre-configured protocol with the Content Provider or the BM-SC. In this respect, the Content Provider and/or the BM-SC can mark the application signaling session by applying a value scheme in one or a few of the session parameters for the sessions. In one implementation, the Content Provider and/or BM-SC use a combination of ARP priority, QCI and TMGI to inform the MCE of the application signaling session, and the MCE identifies the application signaling session by comparing the combination of ARP priority, QCI and TMGI of the sessions in the list of ongoing sessions. FIG. 3 is a schematic illustration of resource allocation in subframes 0-9 of radio frames 0-7 for an MSP of 80 ms according to an embodiment. As shown in FIG. 3, the Content Provider and/or the BM-SC assigns ARP priority value 1 for session S1, and ARP priority value 15 for session S2. The MCE sorts the ARP priority values of the ongoing sessions in an increasing order, thus with S1 at the top of the sorted list. Thus MCE will take S1 as the application signaling session.

In step S203, the MCE puts the application signaling session as the first MTCH in the MCH to secure robust transportation of the application signaling session. As shown in FIG. 3, MSI and MCCH are placed in the first subframe of the MCH, i.e. subframe 3 in radio frame 0. The first sub-frame will always be encoded with signaling MCS as defined in SIB13 of the MBSFN configuration in order to make sure the MSI and MCCH can be robustly received by wireless devices in all the MBSFN coverage areas. Since S1 is allocated as the first MTCH in the MCH, the user data of S1 is placed in the leftover part in the first subframe together with MSI and MCCH, and are encoded together in an MAC PDU with the signaling MCS. By doing this, the MCE uses the leftover part in the first subframe to get the application signaling session transmitted without setting up a dedicated MCH for transmitting the application signaling session, thus making efficient use of the available radio resources.

In step S204, the MCE, if needed, further allocates at least one extra sub-frame for the application signaling session based on the session's GBR and the leftover capacity in the first subframe. In this respect the MCE can calculate the values of the MSI size and MCCH size, and deduct these values from the total number of bits of the first subframe. The MCE is thereby enabled to determine how much extra capacity and subframes are needed to carry all the user data in each MSP as specified in the session's GBR. FIG. 4 is a schematic illustration of resource allocation in subframes 0-9 of radio frames 0-7 for an MSP of 80 ms according to an embodiment. As shown in FIG. 4, the MCE checks the current MSI and MCCH size and the session's GBR, and concludes that one extra subframe with signaling MCS is needed for S1. The MCE updates MBSFN Area information in SIB13 with Sf-AllocInfo=001100, i.e. that sub-frames 3 and 6 will be encoded with signaling MCS.

FIG. 8 schematically illustrates, in terms of a number of functional units, the components of a radio access network node 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 1010 (as in FIG. 10), e.g. in the form of a storage medium 260. The processing circuitry 210 may further be provided as at least one application specific integrated circuit (ASIC), or field programmable gate array (FPGA).

Particularly, the processing circuitry 210 is configured to cause the radio access network node 200 to perform a set of operations, or steps, S102-S112, S201-S204, as disclosed above. For example, the storage medium 260 may store the set of operations, and the processing circuitry 210 may be configured to retrieve the set of operations from the storage medium 260 to cause the radio access network node 200 to perform the set of operations. The set of operations may be provided as a set of executable instructions.

Thus the processing circuitry 210 is thereby arranged to execute methods as herein disclosed. The storage medium 260 may also comprise persistent storage, which, for example, can be any single one or combination of magnetic memory, optical memory, solid state memory or even remotely mounted memory.

A data memory 250 is provided for reading and/or storing data during execution of software instructions in the processor 210. The data memory 250 can be any combination of read and write memory (RAM) and read only memory (ROM).

An input/output (I/O) interface 240 is provided for communicating with other external entities. Optionally, the I/O interface 240 also includes a user interface. The I/O interface 240 is at least configured for communications with the MME 140 over interface M3 and the AN 110 over interface M2.

An optional transceiver (Tx/Rx) 220 can be provided that comprises suitable analogue and digital components to allow signal transmission and signal reception, for example using one or more antennas (Ant) 230.

The processing circuitry 210 controls the general operation of the radio access network node 200 e.g. by sending data and control signals to the I/O interface 240 and the storage medium 260, by receiving data and reports from the I/O interface 240, and by retrieving data and instructions from the storage medium 260. Other components, as well as the related functionality, of the radio access network node 200 are omitted in order not to obscure the concepts presented herein.

FIG. 9 schematically illustrates, in terms of a number of functional modules, the components of a radio access network node 200 according to an embodiment. The radio access network node 200 of FIG. 9 comprises a number of functional modules; an obtainer module 210a configured to perform step S102, and an allocator module 210b configured to perform step S104. The radio access network node 200 of FIG. 9 may further comprises a number of optional functional modules, such as any of a receiver module 210c configured to perform step S102a, a modifier module 210d configured to perform step S102b, an obtainer module 210e configured to perform step S102c, a definer module 210f configured to perform step S102d, a placer module 210g configured to perform step S108, an allocator module 210h configured to perform step S106, and a transmitter module 210i configured to perform step S110.

In general terms, each functional module 210a-210i may in one embodiment be implemented only in hardware or and in another embodiment with the help of software, i.e., the latter embodiment having computer program instructions stored on the storage medium 230 which when run on the processing circuitry makes the radio access network node 200 perform the corresponding steps mentioned above in conjunction with FIG. 9. It should also be mentioned that even though the modules correspond to parts of a computer program, they do not need to be separate modules therein, but the way in which they are implemented in software is dependent on the programming language used. Preferably, one or more or all functional modules 210a-210i may be implemented by the processing circuitry 210, possibly in cooperation with functional units 220 and/or 230. The processing circuitry 210 may thus be configured to from the storage medium 230 fetch instructions as provided by a functional module 210a-210i and to execute these instructions, thereby performing any steps as disclosed herein.

The radio access network node 200 can be provided as a standalone device or as a part of at least one further device. For example, the radio access network node 200 may be provided in a special purpose node of the radio access network or in an existing node of the of the radio access network. Alternatively, functionality of the radio access network node 200 may be distributed between at least two devices, or nodes. For example, according to an embodiment the radio access network node 200 is an MCE.

Thus, a first portion of the instructions performed by the radio access network node 200 may be executed in a first device, and a second portion of the of the instructions performed by the radio access network node 200 may be executed in a second device; the herein disclosed embodiments are not limited to any particular number of devices on which the instructions performed by the radio access network node 200 may be executed. Hence, the methods according to the herein disclosed embodiments are suitable to be performed by a radio access network node 200 residing in a cloud computational environment. Therefore, although a single processing circuitry 210 is illustrated in FIG. 8 the processing circuitry 210 may be distributed among a plurality of devices, or nodes. The same applies to the functional modules 210a-210i of FIG. 9 and the computer program 1020 of FIG. 10 (see below).

FIG. 10 shows one example of a computer program product 1010 comprising computer readable storage medium 1030. On this computer readable storage medium 1030, a computer program 1020 can be stored, which computer program 1020 can cause the processing circuitry 210 and thereto operatively coupled entities and devices, such as the communications interface 220 and the storage medium 230, to execute methods according to embodiments described herein. The computer program 1020 and/or computer program product 1010 may thus provide means for performing any steps as herein disclosed.

In the example of FIG. 10, the computer program product 1010 is illustrated as an optical disc, such as a CD (compact disc) or a DVD (digital versatile disc) or a Blu-Ray disc. The computer program product 1010 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1020 is here schematically shown as a track on the depicted optical disk, the computer program 1020 can be stored in any way which is suitable for the computer program product 1010.

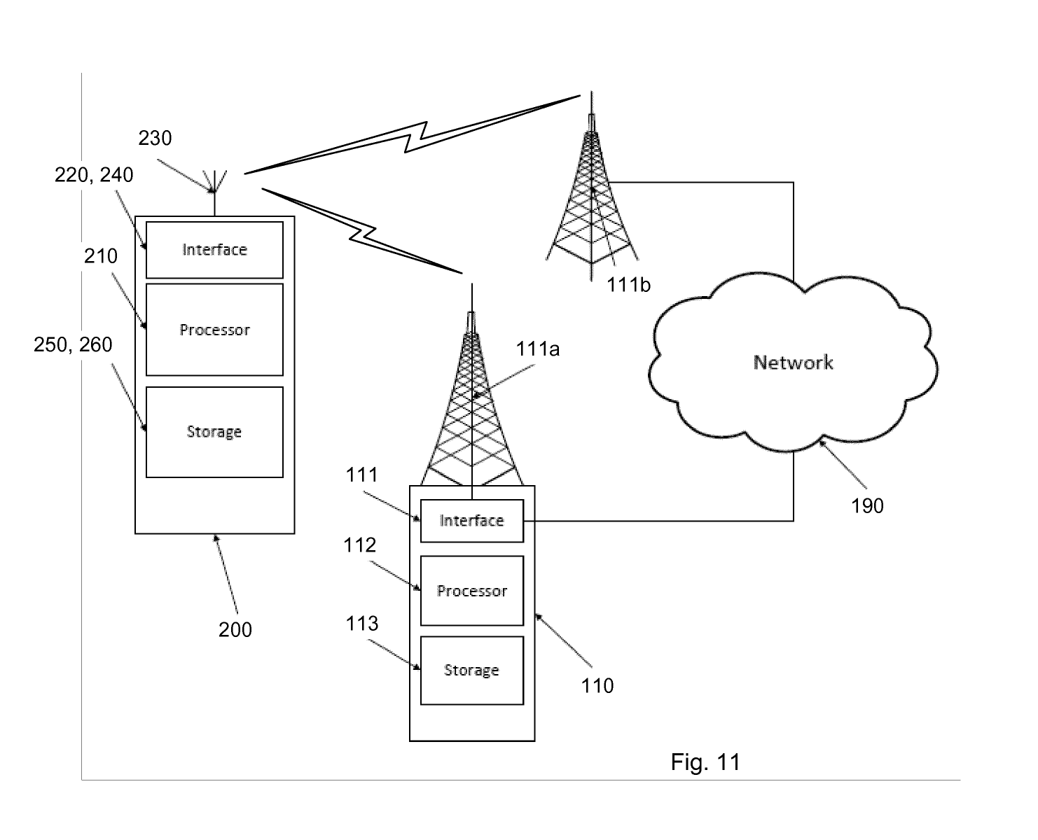

FIG. 11 illustrates a communications network comprising a more detailed view of access node 110 and wireless device (WD) 200 of FIG. 1, in accordance with a particular embodiment. For simplicity, FIG. 11 depicts a network 190, access node 110, and WD 200. Access node 110 comprises processor 112, storage 113, interface 111, and antenna 111a, 111b. Similarly, WD 200 comprises processor 210, storage 250, 260, interface 220, 240 and antenna 230 (as in FIG. 8). These components may work together in order to provide access node and/or wireless device functionality, such as providing wireless connections in a communications network. In different embodiments, the communications network may comprise any number of wired or communications networks, access nodes, base stations, controllers, wireless devices, relay stations, and/or any other components that may facilitate or participate in the communication of data and/or signals whether via wired or wireless connections.

Network 190 may comprise one or more IP networks, public switched telephone networks (PSTNs), packet data networks, optical networks, wide area networks (WANs), local area networks (LANs), wireless local area networks (WLANs), wired networks, communications networks, metropolitan area networks, and other networks to enable communication between devices.

Access node 110 comprises processor 112, storage 113, interface 111, and antenna 111a, 111b. These components are depicted as single boxes located within a single larger box. In practice however, an access node may comprises multiple different physical components that make up a single illustrated component (e.g., interface 111 may comprise terminals for coupling wires for a wired connection and a radio transceiver for a wireless connection). As another example, access node 110 may be a virtual access node in which multiple different physically separate components interact to provide the functionality of access node 110 (e.g., processor 112 may comprise three separate processors located in three separate enclosures, where each processor is responsible for a different function for a particular instance of access node 110). Similarly, access node 110 may be composed of multiple physically separate components (e.g., a NodeB component and a RNC component, a BTS component and a BSC component, etc.), which may each have their own respective processor, storage, and interface components. In certain scenarios in which access node 110 comprises multiple separate components (e.g., BTS and BSC components), one or more of the separate components may be shared among several access nodes. For example, a single RNC may control multiple NodeB's. In such a scenario, each unique NodeB and BSC pair, may be a separate access node. In some embodiments, access node 110 may be configured to support multiple radio access technologies (RATs). In such embodiments, some components may be duplicated (e.g., separate storage 113 for the different RATs) and some components may be reused (e.g., the same antenna 111a, 111b may be shared by the RATs).

Processor 112 may be a combination of one or more of a microprocessor, controller, microcontroller, central processing unit, digital signal processor, application specific integrated circuit, field programmable gate array, or any other suitable computing device, resource, or combination of hardware, software and/or encoded logic operable to provide, either alone or in conjunction with other access node 110 components, such as storage 113, access node 110 functionality. For example, processor 112 may execute instructions stored in storage 113. Such functionality may include providing various wireless features discussed herein to a wireless devices, such as WD 200, including any of the features or benefits disclosed herein.

Storage 113 may comprise any form of volatile or non-volatile computer readable memory including, without limitation, persistent storage, solid state memory, remotely mounted memory, magnetic media, optical media, random access memory (RAM), read-only memory (ROM), removable media, or any other suitable local or remote memory component. Storage 113 may store any suitable instructions, data or information, including software and encoded logic, utilized by access node 110. Storage 113 may be used to store any calculations made by processor 112 and/or any data received via interface 111.

Access node 110 also comprises interface 111 which may be used in the wired or wireless communication of signalling and/or data between access node 110, network 190, and/or WD 200. For example, interface 111 may perform any formatting, coding, or translating that may be needed to allow access node 110 to send and receive data from network 190 over a wired connection. Interface 111 may also include a radio transmitter and/or receiver that may be coupled to or a part of antenna 111a, 111b. The radio may receive digital data that is to be sent out to other access nodes or WDs via a wireless connection. The radio may convert the digital data into a radio signal having the appropriate channel and bandwidth parameters. The radio signal may then be transmitted via antenna 111a, 111b to the appropriate recipient (e.g., WD 200).

Antenna 111a, 111b may be any type of antenna capable of transmitting and receiving data and/or signals wirelessly. In some embodiments, antenna 111a, 111b may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line.

WD 200 may be any type of wireless endpoint, mobile station, mobile phone, wireless local loop phone, smartphone, user equipment, desktop computer, PDA, cell phone, tablet, laptop, VoIP phone or handset, which is able to wirelessly send and receive data and/or signals to and from an access node, such as access node 110 and/or other WDs. WD 200 comprises processor 210, storage 250, 260, interface 220, 240, and antenna 230. Like access node 110, the components of WD 200 are depicted as single boxes located within a single larger box, however in practice a wireless device may comprises multiple different physical components that make up a single illustrated component (e.g., storage 250, 260 may comprise multiple discrete microchips, each microchip representing a portion of the total storage capacity).

Processor 210 may be a combination of one or more of a microprocessor, controller, microcontroller, central processing unit, digital signal processor, application specific integrated circuit, field programmable gate array, or any other suitable computing device, resource, or combination of hardware, software and/or encoded logic operable to provide, either alone or in combination with other WD 200 components, such as storage 250, 260, WD 200 functionality. Such functionality may include providing various wireless features discussed herein, including any of the features or benefits disclosed herein.

Storage 250, 260 may be any form of volatile or non-volatile memory including, without limitation, persistent storage, solid state memory, remotely mounted memory, magnetic media, optical media, random access memory (RAM), read-only memory (ROM), removable media, or any other suitable local or remote memory component. Storage 250, 260 may store any suitable data, instructions, or information, including software and encoded logic, utilized by WD 200. Storage 250, 260 may be used to store any calculations made by processor 210 and/or any data received via interface 220, 240.

Interface 220, 240 may be used in the wireless communication of signalling and/or data between WD 200 and access node 110. For example, interface 220, 240 may perform any formatting, coding, or translating that may be needed to allow WD 200 to send and receive data from access node 110 over a wireless connection. Interface 220, 240 may also include a radio transmitter and/or receiver that may be coupled to or a part of antenna 230. The radio may receive digital data that is to be sent out to access node 111 via a wireless connection. The radio may convert the digital data into a radio signal having the appropriate channel and bandwidth parameters. The radio signal may then be transmitted via antenna 230 to access node 110.

Antenna 230 may be any type of antenna capable of transmitting and receiving data and/or signals wirelessly. In some embodiments, antenna 230 may comprise one or more omni-directional, sector or panel antennas operable to transmit/receive radio signals between 2 GHz and 66 GHz. For simplicity, antenna 230 may be considered a part of interface 220, 240 to the extent that a wireless signal is being used.

Any steps described herein are merely illustrative of certain embodiments. It is not required that all embodiments incorporate all the steps disclosed nor that the steps be performed in the exact order depicted or described herein.

Furthermore, some embodiments may include steps not illustrated or described herein, including steps inherent to one or more of the steps disclosed herein.

Any appropriate steps, methods, or functions may be performed through a computer program product, as in FIG. 10, that may, for example, be executed by the components and equipment illustrated in FIG. 11. For example, storage 113 may comprise computer readable means on which a computer program can be stored. The computer program may include instructions which cause processor 112 (and any operatively coupled entities and devices, such as interface 111 and storage 113) to execute methods according to embodiments described herein. The computer program and/or computer program product may thus provide means for performing any steps herein disclosed.

Any appropriate steps, methods, or functions may be performed through one or more functional modules, as in FIG. 9. Each functional module may comprise software, computer programs, sub-routines, libraries, source code, or any other form of executable instructions that are executed by, for example, a processor. In some embodiments, each functional module may be implemented in hardware and/or in software. For example, one or more or all functional modules may be implemented by processors 210 and/or 112, possibly in cooperation with storage 250, 260 and/or 113. Processors 210 and/or 112 and storage 250, 260 and/or 113 may thus be arranged to allow processors 210 and/or 112 to fetch instructions from storage 250, 260 and/or 113 and execute the fetched instructions to allow the respective functional module to perform any steps or functions disclosed herein.

Certain aspects of the inventive concept have mainly been described above with reference to a few embodiments. However, as is readily appreciated by a person skilled in the art, embodiments other than the ones disclosed above are equally possible and within the scope of the inventive concept. Similarly, while a number of different combinations have been discussed, all possible combinations have not been disclosed. One skilled in the art would appreciate that other combinations exist and are within the scope of the inventive concept. Moreover, as is understood by the skilled person, the herein disclosed embodiments are as such applicable also to other standards and communication systems and any feature from a particular figure disclosed in connection with other features may be applicable to any other figure and or combined with different features.

Although a few embodiments have been described in some detail above, as is readily appreciated by a person skilled in the art, other embodiments than the ones disclosed above are equally possible and within the scope of the inventive concept.

1. A method for allocating an application signalling session for transmitting Multimedia Broadcast Multicast Services, MBMS, data in an MBMS Single Frequency Network, MBSFN, the method being performed by a radio access network node, the method comprising:
obtaining information identifying the application signalling session from a broadcast multicast service center, BM-SC; and
allocating the application signalling session to a subframe of a radio frame, in which subframe a signalling modulation and coding scheme, MCS, of the radio frame is used.

2. The method according to claim 1, wherein the subframe is a first available subframe where a Multicast Traffic Channel, MTCH, is transmitted in a Multicast Channel, MCH.

3. The method according to claim 1, wherein the subframe is a first available subframe of a Multicast Channel Scheduling Period, MSP.

4. The method according to claim 1, wherein the subframe is a first available subframe in the radio frame where multicast Channel Scheduling Information, MSI, is transmitted.

5. The method according to claim 4, wherein the subframe is a first available subframe where a Multicast Control Channel, MCCH, is transmitted.

6. The method according to claim 1, wherein obtaining information identifying the application signalling session comprises:
receiving a session event of the application signalling session from a Mobility Management Entity, MME.

7. The method according to claim 6, wherein obtaining information identifying the application signalling session comprises:
modifying the application signalling session in a list of ongoing sessions in response to having received the session event.

8. The method according to claim 1, wherein obtaining information identifying the application signalling session comprises:
obtaining a sorted list of session events according to values of at least one parameter of the session events; and
defining the information identifying the application signalling session as the session event occurring either first or last in the sorted list of session events.

9. The method according to claim 8, wherein the at least one parameter represent at least one of Allocation and Retention Priority, APR, priority, Quality of service Class Identifier, QCI, and Temporary Mobile Group Identity, TMGI, for the at least two sessions.

10. The method according to claim 1, wherein the signalling MCS is defined in System Information Block 13, SIB 13, of a MBSFN configuration.

11. The method according to 1, further comprising:
placing user data of the application signalling session in any available part of the subframe.

12. The method according to claim 1, further comprising:
allocating at least one further subframe in the radio frame for the application signalling session, wherein the at least one further subframe uses the signalling MCS of the radio frame.

13. The method according to claim 1, wherein the information identifying the application signalling session is obtained from a content provider, CP, via the BM-SC.

14. The method according to claim 1, wherein the radio access network node is a multi-cell/multicast coordination entity, MCE.

15. The method according to claim 11, further comprising:
transmitting the user data as MBMS payload in the subframe.

16. A radio access network node for allocating an application signalling session for transmitting Multimedia Broadcast Multicast Services, MBMS, data in an MBMS Single Frequency Network, MBSFN, the radio access network node comprising processing circuitry, the processing circuitry being configured to cause the radio access network node to:
obtain information identifying the application signalling session from a broadcast multicast service center, BM-SC; and
allocate the application signalling session to a subframe of a radio frame, in which subframe a signalling modulation and coding scheme, MCS, of the radio frame is used.

17. A radio access network node for allocating an application signalling session for transmitting Multimedia Broadcast Multicast Services, MBMS, data in an MBMS Single Frequency Network, MBSFN, the radio access network node comprising:
processing circuitry; and
a computer program product storing instructions that, when executed by the processing circuitry, causes the radio access network node to:
obtain information identifying the application signalling session from a broadcast multicast service center, BM-SC; and
allocate the application signalling session to a subframe of a radio frame, in which subframe a signalling modulation and coding scheme, MCS, of the radio frame is used.

18. A radio access network node for allocating an application signalling session for transmitting Multimedia Broadcast Multicast Services, MBMS, data in an MBMS Single Frequency Network, MBSFN, the radio access network node comprising:
an obtainer module configured to obtain information identifying the application signalling session from a broadcast multicast service center, BM-SC; and
an allocator module configured to allocate the application signalling session to a subframe of a radio frame, in which subframe a signalling modulation and coding scheme, MCS, of the radio frame is used.

19. A non-transitory computer-readable storage medium comprising a computer program product including instructions to cause at least one processor to:
obtain information identifying the application signalling session from a broadcast multicast service center, BM-SC; and
allocate the application signalling session to a subframe of a radio frame, in which subframe a signalling modulation and coding scheme, MCS, of the radio frame is used.

20. (canceled)
